(19) United States
(12) Patent Application Publication
(10) Pub. No.: US 2010/0255331 A1
(43) Pub. Date: Oct. 7, 2010

(54) Compressed Wood Product and Method of Manufacturing Same

(75) Inventors: Tatsuya Suzuki, Setagaya-ku (JP); Yuko Nakajima, Kunitachi-shi (JP)

Correspondence Address: Hogan Lovells US LLP, 1999 AVENUE OF THE STARS, SUITE 1400, LOS ANGELES, CA, 90067, US

(73) Assignee: OLYMPUS CORPORATION, Tokyo (JP)

(21) Appl. No.: 12/817,041

(22) Filed: Jun. 16, 2010

Related U.S. Application Data
(63) Continuation of application No. PCT/JP2008/073904, filed on Dec. 22, 2008.

(30) Foreign Application Priority Data
Dec. 25, 2007 (JP) 2007-332937

(51) Int. Cl. B32B 21/06; B27M 1/02

(52) U.S. Cl. 428/535; 144/344

(57) ABSTRACT

A method of manufacturing a compressed wood product includes attaching a paper piece on a surface of a wooden piece cut-out from raw wood, the paper piece containing vegetable fiber as a main component; and compressing the wooden piece with the paper piece attached thereon to deform the wooden piece into a predetermined shape under a water vapor atmosphere of a temperature and pressure higher than those of an atmospheric air.

### CROSS-REFERENCE TO RELATED APPLICATIONS

This application is a continuation of PCT international application Ser. No. PCT/JP2008/073904 filed on Dec. 22, 2008 which designates the United States, incorporated herein by reference, and which claims the benefit of priority from Japanese Patent Applications No. 2007-332937, filed on Dec. 25, 2007, incorporated herein by reference.

### BACKGROUND OF THE INVENTION

1. Field of the Invention

The present invention relates to a compressed wood product and a method of manufacturing the compressed wood product.

2. Description of the Related Art

In recent years, wooden materials that are natural materials attract attention. With a wide variety of grain patterns, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden materials: a wooden board is softened with water absorption and compressed; the compressed wooden board is cut along a direction substantially parallel with a direction in which the compressive force is applied, whereby a primary fixed product with a sheet-like shape is obtained; and the primary fixed product is deformed into a desired three-dimensional shape under heat and moisture (for example, see Japanese Patent No. 3078452 Publication). Further, according to another conventional technique, a softened wooden sheet is compressed and temporarily secured in a prepared mold and left in the mold until the wooden sheet recovers. Thus a wood product with a desired shape can be obtained (see, for example, Japanese Patent Application Laid-Open No. H11-077619).

The compressed wood products as manufactured above are applied for a variety of uses. It is known, for example, that a compressed wood product is used as an exterior for electronic equipment (see Japanese Patent Application Laid-open No. 2004-64021).

### SUMMARY OF THE INVENTION

A method of manufacturing a compressed wood product according to an aspect of the present invention includes attaching a paper piece on a surface of a wooden piece cut-out from raw wood, the paper piece containing vegetable fiber as a main component; and compressing the wooden piece with the paper piece attached thereon to deform the wooden piece into a predetermined shape under a water vapor atmosphere of a temperature and pressure higher than those of an atmospheric air.

A compressed wood product according to another aspect of the present invention includes a compressed wooden piece; and a paper piece provided on a surface of the wooden piece and having a surface smoothly-continued with the surface of the wooden piece, the paper piece containing vegetable fiber as a main component.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart showing an outline of a method of manufacturing a compressed wood product according to an embodiment of the present invention;

FIG. 2 shows an outline of a cutting-out process in the method of manufacturing the compressed wood product;

FIG. 3 shows an outline of a paper-piece attaching process in the method of manufacturing the compressed wood product;

FIG. 4 shows an outline of a compression process in the method of manufacturing the compressed wood product;

FIG. 5 is a cross-sectional view taken along A-A line of FIG. 4;

FIG. 6 is the wooden piece which has been substantially deformed in the compression process;

FIG. 7 is a partial cross-sectional view of FIG. 6;

FIG. 8 is a perspective view of a configuration of a compressed wood product according to an embodiment of the present invention;

FIG. 9 is a perspective view of a configuration of a digital camera which is housed in the compressed wood product as an exterior for electronic equipment;

FIG. 10 is a perspective view of a configuration of a compressed wood product according to another embodiment of the present invention; and

FIG. 11 is a cross-sectional view taken along B-B line of FIG. 10.

### DETAILED DESCRIPTION OF THE PREFERRED EMBODIMENTS

Preferred embodiments of the present invention (hereinafter simply referred to as embodiments) will be described below with reference to the accompanying drawings. The drawings referred to below include schematic diagrams and views; some objects can be presented in different dimension and scale over the drawings even if the objects are the same.

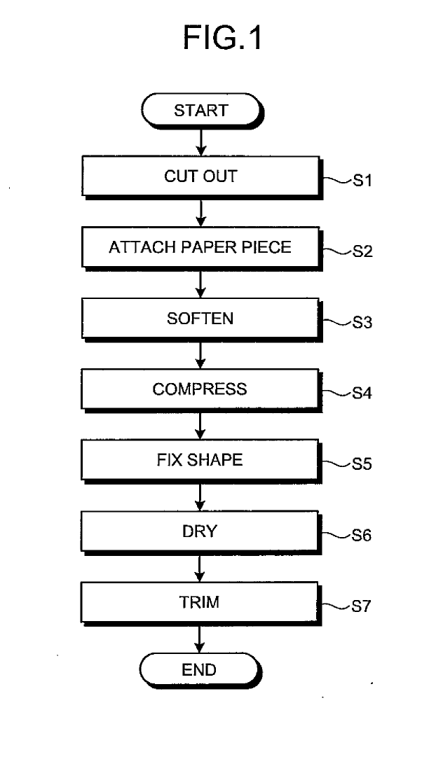

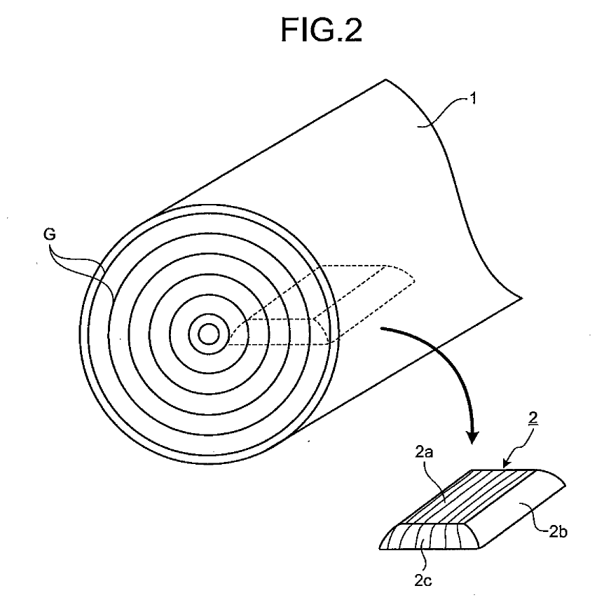

FIG. 1 is a flowchart showing an outline of a method of manufacturing a compressed wood product according to an embodiment of the present invention. Before a compressed wood product is manufactured, firstly, a wooden piece of a predetermined shape is cut out from raw wood (cutting-out process) before it is formed (Step S1). FIG. 2 schematically shows an outline of the cutting-out process. In the cutting-out process, a wooden piece 2 having a substantially dish-like shape is cut out from uncompressed raw wood 1 by cutting or the like. The raw wood 1 may be selected, for example, from various types of wood, such as, Japanese cypress, hiba cedar, paulownia, Japanese cedar, pine, cherry, zelkova, ebony wood, bamboo, teak, mahogany, and rosewood as appropriate depending on the use of the processed wooden piece.

The wooden piece 2 includes a substantially rectangular main plate portion 2a, two side plate portions 2b that curve and extend from two lengthwise sides of the main plate portion 2a, respectively, which are facing with each other on the surface of the main plate portion 2a, and two side plate portions 2c that are bent and extend from two breadthwise sides of the main plate portion 2a, respectively, which are facing with each other on the surface of the main plate portion 2a. The wooden piece 2 has a volume which is larger than a finished product by an amount to be decreased during compression process described later. The wooden piece 2 shown in FIG. 2 has a flat-grain pattern G, which is substantially parallel with the direction of the wooden fibers of the wooden piece 2, but it is one example. Alternatively, the wooden piece 2 may have a straight-grain pattern.

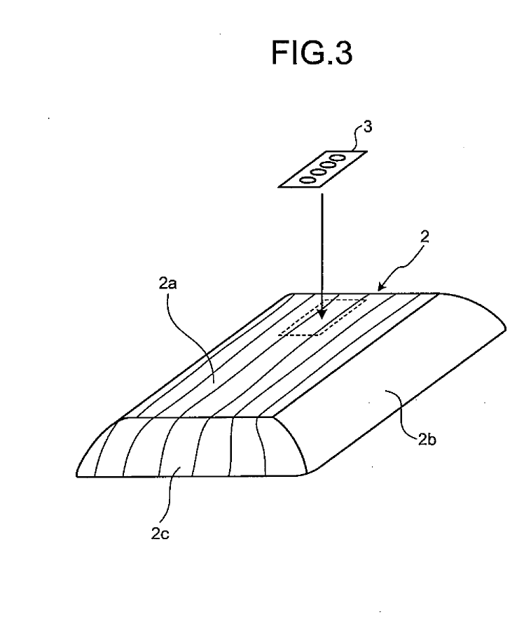

After Step 1, a paper piece is attached on the wooden piece 2 (Step S2). FIG. 3 shows an outline of a paper-piece attaching process of Step S2. On a paper piece 3 which contains vegetable fiber as its main component, predetermined information is printed in advance. As described later, a compressed wood product according to this embodiment is formed from the wooden piece 2 to be used as an exterior of a digital camera. Accordingly, information (logo) such as product name and manufacturer of the digital camera is printed on the paper piece 3 attached on the main plate portion 2a, as shown in FIG. 3.

The paper piece 3 is bonded to the wooden piece 2 by applying adhesive to at least a part of a contact surface of the paper piece 3 with the wooden piece 2, so that the paper piece 3 is placed at a predetermined position on the wooden piece 2. Accordingly, the paper piece 3 may be a strip with glue applied on a part of its surface. It should be noted that the adhesive is used to fix the paper piece 3 at the predetermined position on the wooden piece 2 but not to strongly bond the paper piece 3 to the wooden piece 2.

After Step S2, the wooden piece 2 is left in a water vapor atmosphere of a temperature and pressure higher than those of an atmospheric air for a predetermined time period, whereby the wooden piece 2 is softened through absorption of moisture in excess (Step S3). Here, the high temperature is about 100 to 230° C. and the high pressure is about 0.1 to 3.0 MPa (MegaPascal). Such a water vapor atmosphere can be provided by a pressure vessel. If the pressure vessel is used, the softening process is that the wooden piece 2 is left in the pressure vessel. The softening process at Step S3 may include heating the wooden piece 2 with high-frequency electromagnetic wave like microwave after the surface of the wooden piece 2 is exposed to water vapor, or boiling the wooden piece 2.

After Step S3, the softened wooden piece 2 is compressed (Step S4). At Step S4, the softened wooden piece 2 is deformed into a predetermined three-dimensional shape in such a manner that the wooden piece 2 is sandwiched by a pair of metal molds so as to be subjected to a compressive force in the water vapor atmosphere where the wooden piece 2 is softened. If the pressure vessel is used for the softening process, the wooden piece 2 may be subsequently compressed in the same pressure vessel.

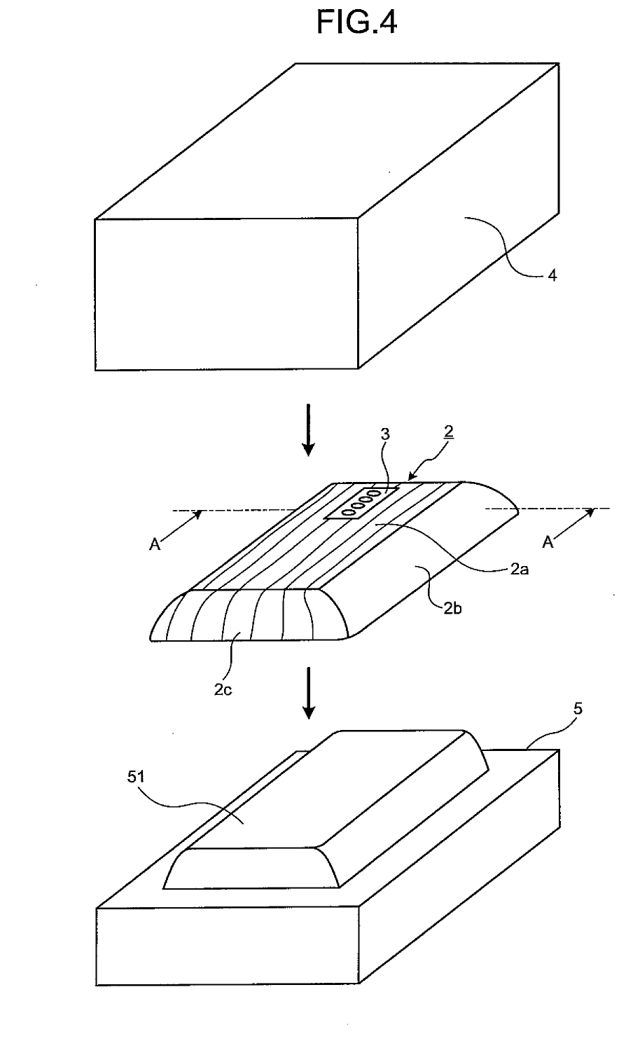

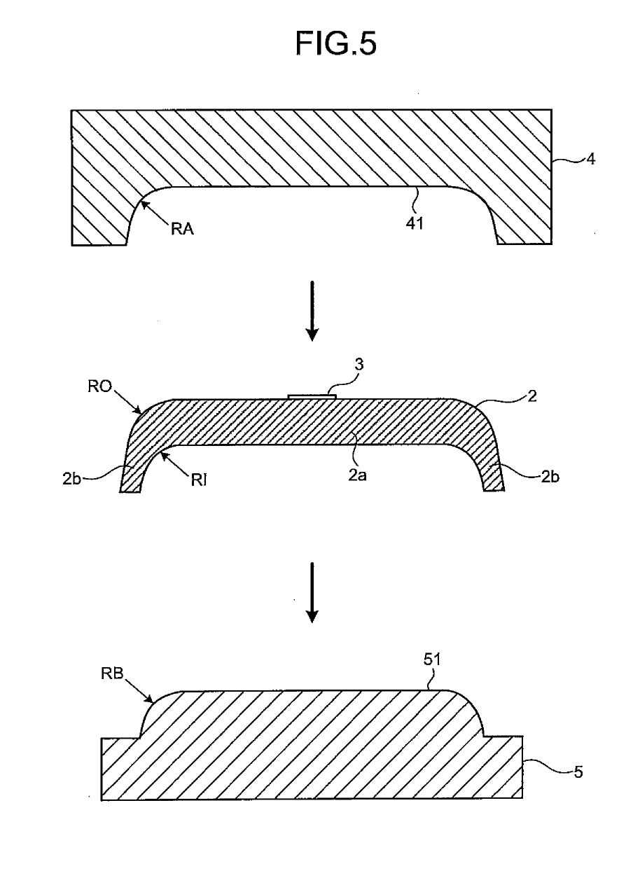

FIG. 4 shows an outline of the compression process and a configuration of the pair of metal molds used in the compression process in the method of processing the wooden piece. FIG. 5 is a cross-sectional view taken along A-A line of FIG. 4. As shown in FIGS. 4 and 5, the wooden piece 2 is sandwiched and compressed by a pair of metal molds 4 and 5.

Of the pair of metal molds, a metal mold 4 which applies compressive force to the wooden piece 2 from above during compression is a cavity metal mold which has a depression 41 that fits to the external face of the wooden piece 2. When the radius of curvature of an external face of a curved portion extending from the main plate portion 2a to the side plate portion 2b of the wooden piece 2 is represented as RO, and the radius of curvature of a curved surface of the depression 41, which abuts the external of the curved portion, is represented as RA, the relation represented by RO>RA holds.

On the other hand, a metal mold 5 which applies compressive force to the wooden piece 2 from below during compression is a core metal mold which has a protrusion 51 that fits to an internal face of the wooden piece 2. When the radius of curvature of an internal face of a curved portion extending from the main plate portion 2a to the side plate portion 2b of the wooden piece 2 is represented as RI, and the radius of curvature of a curved surface of the protrusion 51, which abuts the internal face of the curved portion is represented as RB, the relation represented by RI>RB holds.

The metal molds 4 and 5 are clamped by a clamping jig after sandwiching the wooden piece 2. FIG. 6 shows a state where the clamped metal molds 4 and 5 apply compressive force to the wooden piece 2, and where the deformation of the wooden piece 2 has nearly completed. As shown in FIG. 6, the wooden piece 2 is deformed into a three-dimensional shape corresponding to the shape of a gap between the metal molds 4 and 5 by the application of compressive force from the metal molds 4 and 5.

A space between the wooden piece 2 and the paper piece 3 is erased by the compression so that a step between the wooden piece 2 and the paper piece 3 disappears. Accordingly, the surface of the paper piece 3 is smoothly continued with the surface of the wooden piece 2.

After the wooden piece 2 is compressed for a predetermined time period (one to dozens of minutes, or more preferably approximately 5 to 10 minutes) in the state shown in FIG. 6, water vapor of a temperature higher than the water vapor used in the compression process is applied to the clamped metal molds 4 and 5 to fix the shape of the wooden piece 2 (Step S5). If the pressure vessel is used in the fixing process, water vapor of a temperature higher than the water vapor used in the compression process may be introduced into the pressure vessel.

After Step S6, the water vapor atmosphere is removed to dry the wooden piece 2 (Step S6). In order to facilitate drying of the wooden piece 2, the metal molds 4 and 5 may be separated from each other so that the wooden piece 2 is released from the clamping.

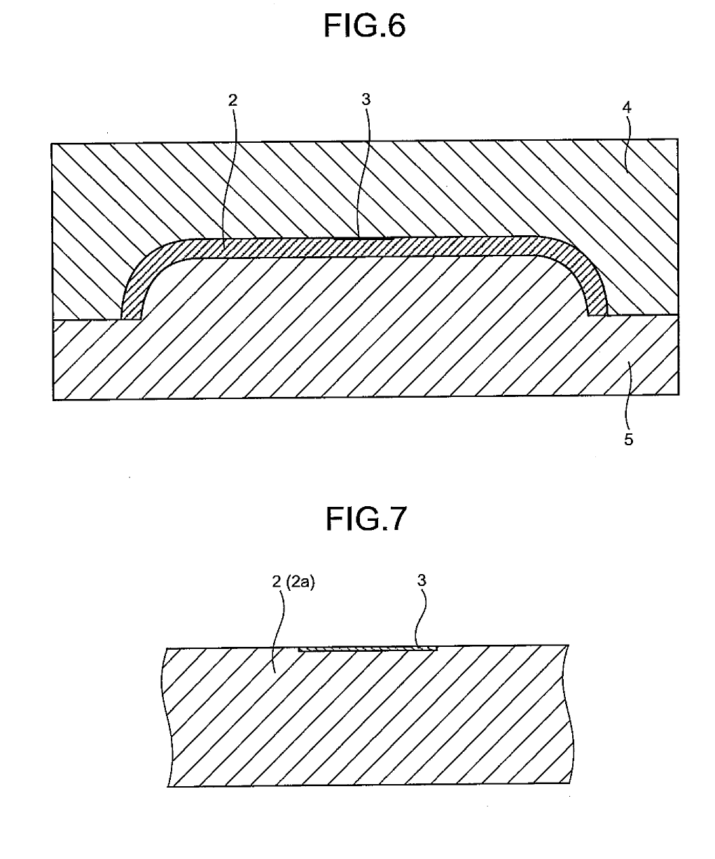

FIG. 7 is a partial cross-sectional view showing a configuration of the dried wooden piece 2 and the paper piece 3. In FIG. 7, the surface of the paper piece 3 is in the plane which contains the surface of the wooden piece 2 around the paper piece 3. This continuous surface is caused by embedding the paper piece 3 slightly-compressed in the compression process into the wooden piece 2. Embedding the paper piece 3 into the wooden piece 2 has no impact on compressing the wooden piece 2 because the thickness of the paper piece 3 is considerably smaller than the thickness of the wooden piece 2.

The thickness of the dried wooden piece 2 is preferably about 30% to 50% of the wooden piece 2 before the compression. This means that the compression rate of the wooden piece 2, AR/R where AR is a reduced thickness of the wooden piece 2 after the compression and R is a thickness of the wooden piece 2 before the compression, is about 0.50 to 0.70.

After the wooden piece 2 and the paper piece 3 are dried, the wooden piece 2 is trimmed into a finished shape through a process such as cutting and punching (Step S7).

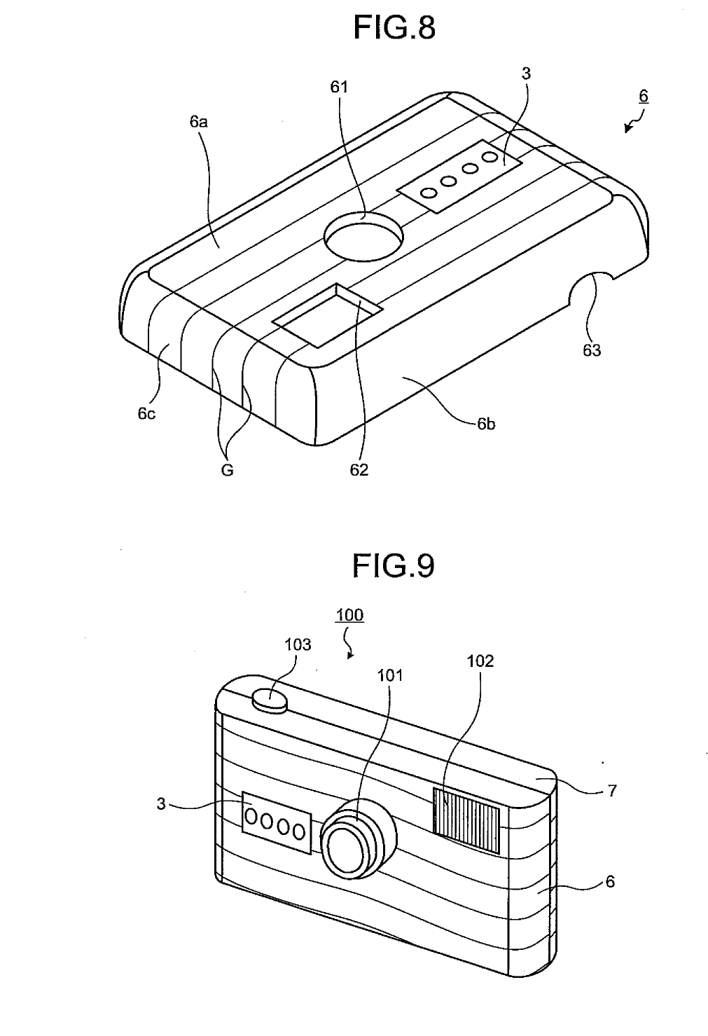

FIG. 8 is a perspective view of a configuration of a compressed wood product manufactured by the method described above. The compressed wood product 6 shown in FIG. 8 is an exterior for covering the front side of a digital camera (the side facing a subject), and includes a main plate portion 6a, side plate portions 6b and 6c corresponding respectively to the main plate portion 2a, side plate portions 2b and 2c of the wooden piece 2. The main plate portion 6a has a circular opening 61 through which an image pick-up unit of the digital camera is exposed and a rectangular opening 62 through which a photoflash of the digital camera is exposed. The side plate portion 6b has a semicircular notch 63 through which a shutter button is exposed.

The wooden piece 2 has an affinity for the paper piece 3 because the wooden piece 2 contains a resin component similar to vegetable fiber of the paper piece 3. Consequently, the resin component infiltrates at least a surface of the paper piece 3 which is in contact with the wooden piece 2. Since the compressed wood product 6 is integrated with the paper piece 3 through the infiltrated resin component of the wooden piece 2, the paper piece 3 is difficult to peel off from the main body of the compressed wood product 6. Moreover, since each of the wooden piece 2 and the paper piece 3 of the compressed wood product 6 contains a vegetable fiber-based material, it is unnecessary to separate the paper piece 2 from the main body of the compressed wood product 6 when the compressed wood product 6 is discarded.

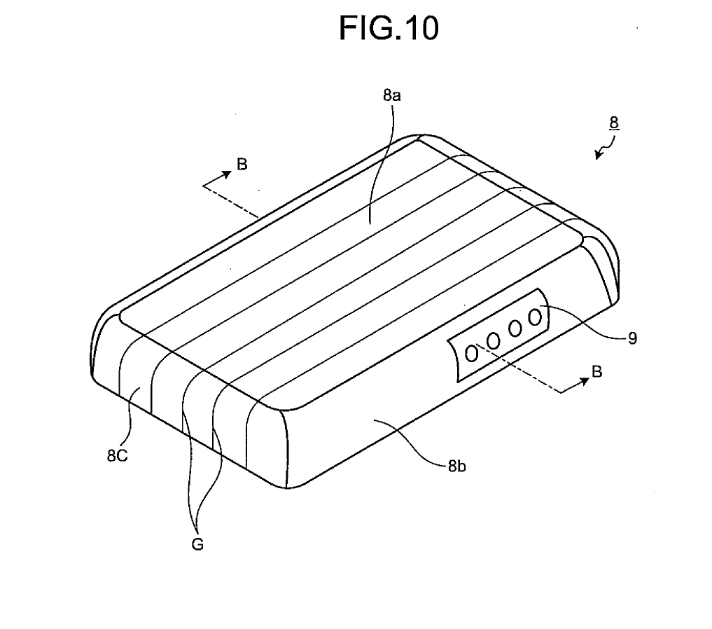

FIG. 9 is a perspective view of a configuration of a digital camera whose front side is covered by the compressed wood product 6. The digital camera 100 shown in FIG. 9 includes an image pick-up unit 101, a photoflash 102, a shutter button 103. The front side of the digital camera 100 through which the image pick-up unit 101 and the photoflash 102 are exposed is covered by the compressed wood product 6. On the other hand, the back side of the digital camera 100 is covered by a compressed wood product 7 which is manufactured from the wooden piece 2 in the same manner as in the compressed wood product 6.

A compressed wood product according to the embodiment is applicable to an exterior for electronic equipment other than digital cameras. For example, the compressed wood product for an exterior for portable electronic equipment preferably has a thickness of 1.6 to 2.0 mm.

According to the embodiment described above, compressing a wooden piece with a paper piece attached thereon results in smoothly-continued surfaces of the wooden piece and the paper piece and in an infiltrated resin component of the wooden piece in the paper piece. Consequently, the paper piece 3 is difficult to peel off from the compressed wooden piece. Moreover, since the paper piece contains a vegetable fiber-based material as contained in the wooden piece, it is unnecessary to separate the paper piece from the wooden piece when the compressed wood product is discarded.

According to the embodiment, the surfaces of the wooden piece and the paper piece are in the same plane without a depression on the surface of the wooden piece.

According to the embodiment, it is easy to change the size of the paper piece to be attached on the surface of the wooden piece. Accordingly, it is possible to provide an appropriate paper piece depending on mandatory information required in a marketable area such as information about the model of electronic equipment (serial number, country of manufacture, etc.), without changing the configuration of the main body.

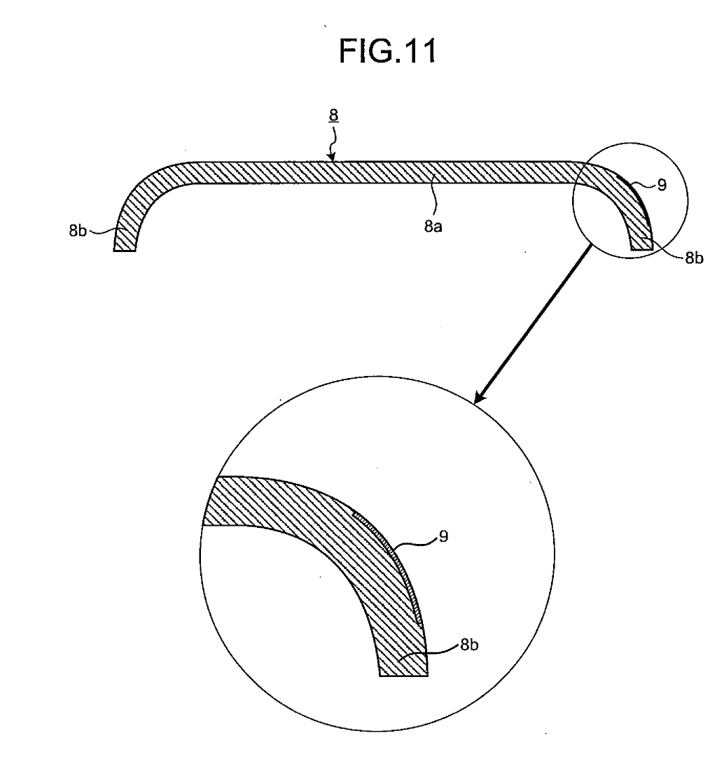

The preferred embodiments of the present invention are described above, but not limited to the invention. FIG. 10 is a perspective view of a configuration of a compressed wood product according to another embodiment of the present invention. FIG. 11 is a cross-sectional view taken along B-B line of FIG. 10. The compressed wood product 8 shown in FIGS. 10 and 11 includes a main plate portion 8a, side plate portions 8b and 8c corresponding respectively to the main plate portion 2a, side plate portions 2b and 2c of the wooden piece 2. A paper piece 9 is attached on the external surface of the side plate portion 8b. The surface of the paper piece 9 is in the place which contains the surface of the external surface of the side plate portion 8b; the paper piece 9 is attached on the surface of the side plate portion 8b before the softening process. As shown in FIGS. 10 and 11, it is easy to attach the paper piece on a curved surface.

According to the present invention, it is possible to form a pattern with paper pieces on the surface of a wooden piece.

The method of manufacturing a compressed wood product piece according to the present invention is also applicable to structural objects other than exteriors for electronic equipment, such as dishes, a variety of housings, and building materials.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a compressed wood product, comprising:
attaching a paper piece on a surface of a wooden piece cut-out from raw wood, the paper piece containing vegetable fiber as a main component; and
compressing the wooden piece with the paper piece attached thereon to deform the wooden piece into a predetermined shape under a water vapor atmosphere of a temperature and pressure higher than those of an atmospheric air.

2. The method according to claim 1, wherein
the wooden piece is compressed so that a surface of the paper piece is in a place which contains the surface of the wooden piece around the paper piece.

3. The method according to claim 1, wherein
in the attaching, at least a part of the paper piece is bonded to the surface of the wooden piece.

4. The method according to claim 1, further comprising
softening the wooden piece after the attaching and before the compressing.

5. A compressed wood product, comprising:
a compressed wooden piece; and
a paper piece provided on a surface of the wooden piece and having a surface smoothly-continued with the surface of the wooden piece, the paper piece containing vegetable fiber as a main component.

6. The compressed wood product according to claim 5, wherein the surface of the paper piece is in a plane which contains the surface of the wooden piece around the paper piece.
